(19) United States
(12) Patent Application Publication
(10) Pub. No.: US 2013/0209325 A1
(43) Pub. Date: Aug. 15, 2013

(54) Discrete, Hidden Fingernail Mounted Date Rape Drug Detection Device

(71) Applicant: Hooshmand Harooni, Los Angeles, CA (US)

(72) Inventor: Hooshmand Harooni, Los Angeles, CA (US)

(21) Appl. No.: 13/370,070

(22) Filed: Feb. 9, 2012

(51) Int. Cl. G01N 21/78

(52) U.S. Cl. 422/400

(57) ABSTRACT

This invention provides for a test strip to detect common “date rape” drugs, which is hidden and discretely mounted on the underside of a fingernail (hereinafter known as “A Discrete, Hidden Fingernail Mounted Date Rape Drug Detection Device”). The test strip will react positively and detect even the smallest amounts of the most common of these so called family of date rape drugs. These drugs currently include but are not limited to gamma-hydroxybutyric acid (“GEM”), drugs in the benzodiazepine family (such as flunitrazepam, or Rohypnol, or “roofies”), and ketazines. The test strip can be in one embodiment mounted on the underside of a fake fingernail, and in another embodiment mounted on the underside of a true long fingernail. When the test strip detects any one of the drugs mentioned above, a change in color will instantaneously alert the drinker that their drink has been tampered with.

### CROSS-REFERENCE TO RELATED APPLICATIONS

Not applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### SUMMARY OF THE INVENTION

A date rape drug can be defined as any drug that can be used to assist in the execution of a unwelcome sexual assault, such as a non-consensual sexual act and/or non-consensual sexual intercourse (“date rape”). Unfortunately, the use of such drugs by members of either sex to utilize them in such acts of unwelcome sexual assault have been on the rise for most of the 21^{st} Century. Date Rape Drugs are used to facilitate sexual assault that may have sedative, hypnotic, dissociative, and/or amnesiac effects, and can be added to a drink without the victim's knowledge. The act of adding such substances to drinks has become known as “drink spiking”, and the reasons for drink spiking are many, and in addition to the unwelcome sexual assault mentioned above can also include maliciousness, theft, and physical or bodily harm.

The different types of drugs that can be potentially utilized in a date rape have also increased during this time period, and include but are not limited to the following. These drugs are generally odorless, colorless, and tasteless and easily remain undetected when introduced to a victim's drink:

i. Gamma-hydroxybutyric acid, or “CHB” drugs. GHB is generally produced in liquid form and is a potential central nervous system depressant that is found naturally in the brain and other human tissue, but in a much smaller concentration. GHB is known by many street names such as “liquid ecstasy”, “liquid X”, and “Grievous Harm to the Body” [“GHB”].

ii. The family of drugs known as benzodiazepines (such as flunitrazepam, also known as Rohypnol, or “roofies”). Rohypnol is generally available, as a white tablet that is used in over 80 countries as a pharmaceutical to treat severe sleep disorders. Rohypnol is known by many street names such as “roofies”, “roaches”, “la Rocha”, and the “forget pill”.

iii. The family of drugs known as ketamines. Ketamines are often found as a while pill or white powder, but can also be produced as a liquid in its pharmaceutical form. Ketamine is used as a general anesthetic utilized extensively in the field of veterinary medicine. It is known by the street name “special K”.

With this type of increased proliferation and unfortunate use of these drugs for the purposes of unwelcome sexual assault, several companies around the world have developed test strips embedded in credit card size testing kits or in drink coasters. However, these methods are not discrete, and cumbersome to use. The subject of this invention, the “A Discrete, Hidden Fingernail Mounted Date Rape Drug Detection Device” achieves the same purpose by very easily alerting the user to the presence of any of the date rape drugs mentioned above in an unsuspecting victim's drink. Unlike the more cumbersome methods of detection, a small test strip mounted under the fingernail can be quickly inserted into a drink for testing purposes without having to take a drop and place on a coaster, or other non-single step methodologies. The user of this device would simply apply the specially equipped fake fingernail before visiting the alcoholic drink establishment, and after insertion for just a few seconds, the fingernail can be quickly removed and the test strip viewed for a change of color that would immediately signify the presence of a date rape drug. In addition, by mounting the test strip under the fingernail, the testing of the drink can be done in a discrete manner so as to not offend the party that the user of the fingernail device is with, in the hoped for majority of cases where a spiking of the drink is actually not occurring.

In addition, for the user who does not wish to apply fake fingernails, the small test strip mentioned above is also available as a separate strip that utilizes adhesive to attach the test strip to the underside of a real, human fingernail. This adhesion can be easily accomplished by applying the test strip carefully to the underside of one fingernail with a pair of tweezers.

In both embodiments (fake and real fingernails), the test strip can be used repeatedly until an actual positive identification of the presence of a date rape drug has been made.

Finally, recent studies have shown the increased use of drugs in the zolpidem family (“Ambien”, “Stilnox”), crystal methamphetamine (“speed”), and opiates, for which detection technology in the form a small test strip are being developed. The use of Ambien as a date rape drug has gained increased popularity because it is completely tasteless, unlike, for example, GHB, which has a reputation of having a slightly salty taste. Once available, these new types of test strips that can detect the presence of zolpidem, crystal methamphetamine, and opiate drugs can also be adapted for use in the unique fingernail application methodology described in this patent application.

### BRIEF DESCRIPTION OF THE DRAWINGS

FIG. 1 A depiction of the “A Discrete, Hidden Fingernail Mounted Date Rape Drug Detection Device” invention that is the subject of this patent, clearly showing the test strip attached under a fake fingernail.

### DETAILED DESCRIPTION OF THE INVENTION

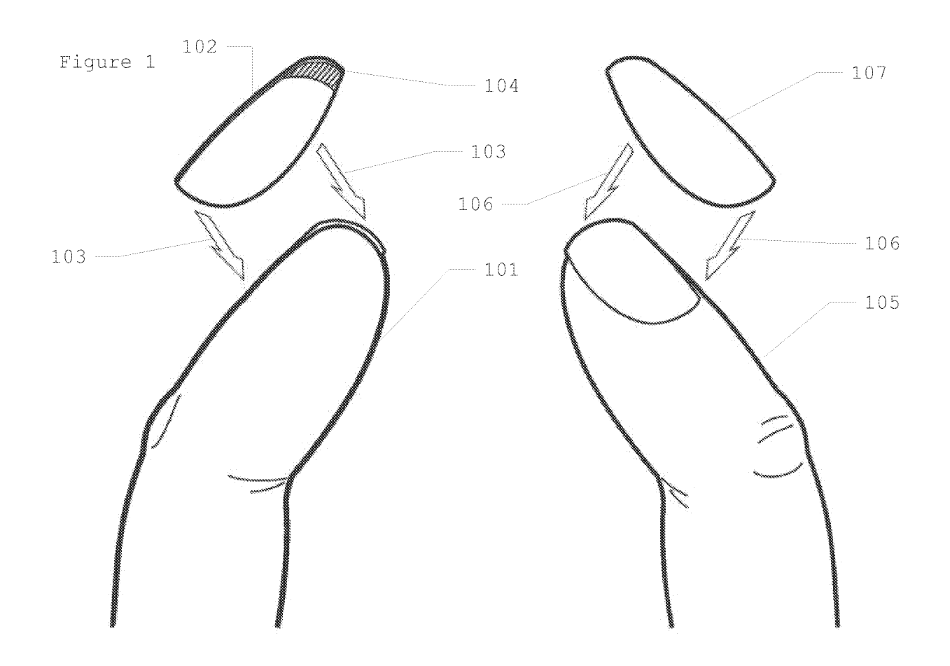

FIG. 1 shows a detailed view of the “A Discrete, Hidden Fingernail Mounted Date Rape Drug Detection Device” invention. 101 shows a human finger depiction shown from the underside of the finger. 102 shows the fake fingernail that is the subject of this patent application, and 104 clearly depicts the test strip attached to the underside surface of said fake fingernail. The arrows at 103 show how the fake fingernail is placed onto the top of the real fingernail on the human subject. 105 shows the same operation of attaching the fingernail, from the top of the human subject's finger, with 107 showing the top side of the “A Discrete, Hidden Fingernail Mounted Date Rape Drug Detection Device” invention, and again the arrows at 106 depict how the fake fingernail is placed onto the fingernail on the human subject.

What is claimed is:

1: This invention (hereinafter known as a “A Discrete, Hidden Fingernail Mounted Date Rape Drug Detection Device”) describes a small “date rape drug” detection test strip mounted discretely and hidden on the underside surface of a fake fingernail. The detection test strip will have the ability to detect all or some of, and at least but not including, the following date rape drugs: (a) gamma-hydroxybutyric acid (“GHB”), (b) drugs in the benzodiazepine family (such as flunitrazepam, or Rohypnol, or “roofies”), and (c) ketazines. The detection test strip will react and produce a unique color change in the test strip itself when the fingernail with attached test strip is placed discretely in a drink to be tested for the presence of any of the date rape drugs.

2: In a specific embodiment of the “A Discrete, Hidden Fingernail Mounted Date Rape Drug Detection Device” in claim 1, the described test strip will be standalone (i.e., not attached to the underside of a fake fingernail), and on one side will be an adhesive strip that allows the test strip to be attached to the underside of a real, long, fingernail. Once attached in this fashion, the test strip will allow for the discrete and hidden detection of date rape drugs by dipping the fingernail with test strip into a drink, suspected of being altered to contain said drugs without the drinker's knowledge in the identical fashion as in claim 1.
